(19) United States
(12) Patent Application Publication
(10) Pub. No.: US 2002/0132035 A1
(43) Pub. Date: Sep. 19, 2002

(54) Synthetic fat composition

(76) Inventors: Dov Tamarkin, Maccabim (IL); Meir Eine, Ness Ziona (IL); Micha Peled, Rehovet (IL)

Correspondence Address: HALE AND DORR, LLP, 60 STATE STREET, BOSTON, MA, 02109

(21) Appl. No.: 09/883,721

(22) Filed: Jun. 18, 2001

(30) Foreign Application Priority Data
Jan. 10, 2001 (IL) PCT/IL01/00024

(51) Int. Cl. A23D 7/00

(52) U.S. Cl. 426/601

(57) ABSTRACT

An oil or fat composition comprising an oil or fat comprising 15 wt. % or more of a synthetic fat and oil and 0.2 to 20 wt. % of a and edible solidifying agents, in particular long chain fatty acids and/or long chain fatty alcohols, dissolved or dispersed in the synthetic fat and oil is provided here, which can be used in the same way as usual oil and fat in daily life to provide health benefits, while avoiding problems in appearance, taste, heating cooking and the like in comparison with usual edible oil and fat.

### BACKGROUND OF THE INVENTION

1. Field of the Invention

The present invention relates to an oil and fat composition which, when used in daily life similarly to ordinary fats, can lower the blood cholesterol level of a person having a high cholesterol level. It further relates to a food, a drink and a therapeutic preparation each containing the oil and fat composition.

2. Background

The levels of oils and fats in Western diets are too high, causing metabolic disturbances and health risks. They are a significant source of calories, providing 9 Kcal/g, compared with 4 Kcal/g for protein and carbohydrates. Thus, they contribute to weight gain and obesity, which have become very common in the industrialized countries. Semi solid and solid fats have become a prominent constituent of our diet. They are needed in order to produce a variety of food products.

Semi-solid and solid fats can be derived from natural sources. They can be isolated from animal substances (e.g., lard and milk fats) or from plants, such as palm and coconut. Another way to obtain semi-solid and solid fat is the partial or full hydrogenation of such oils. Yet, because of this chemical transformation, the oils become saturated and lose their healthy properties.

It is well known, and was further stated by the Food and Drug Administration (FDA), that the intake of saturated fat is linked to high blood cholesterol, which in turn is linked to increased risk of coronary heart disease (CHD) (See “Lowering Cholesterol” in FDA Consumer, March 1994, and “A Consumer's Guide to Fats” in FDA Consumer, May 1994). It has been established that the cardiovascular risk of saturated fats in inversely correlated with the length of their fatty acids: lauric acid (C:12)>palmitic acid (C:14)>arachydic acid (C:16)>stearic acid (C:18). Plant-derived fats are rich in lauric acid and palmitic acids.

Partial hydrogenation also results in the formation of “trans”fatty acids, which have recently been shown to possess a plurality of adverse properties. Structurally, trans fatty acids are similar to saturated fatty acids and hence they influence cell membranes in the same way. Saturated fatty acids inhibit the removal of cholesterol from the blood by inhibiting LDL receptors. Trans fatty acids can also raise LDL cholesterol levels in the blood. Trans fatty acids also apparently elevate lipoprotein[a], a risk factor for heart disease. At high levels of intake, trans fatty acids can also reduce blood levels of HDL cholesterol (the “good cholesterol”) and also interfere with the metabolism of the essential fatty acids. In the Nurses Health Study in Boston it was reported that intake of trans fatty acids was associated with an increased risk of coronary heart disease. Diets high in trans linoleates, which are devoid of essential fatty acid activity, have been demonstrated to retard growth more than diets deficient in essential fatty acids. Trans, trans 18:2-w6 linoleic acid decreases the conversion of linoleic to gamma-linolenic acid in the liver microsomes (Handbook of Lipids in Human Nutrition. Gene Spiller, Ed. (1996) page 92). Trans fatty acids can enter fetus and breast milk. They can be incorporated into a child's developing brain instead of more beneficial fatty acids. A recent European epidemiological study has also revealed an association between ingestion of sizable amounts of trans fatty acids and the prevalence of asthma, allergic rhino conjunctivitis and atopic dermatitis (Lancet 1999; 353:2040-41). Recently, the Food and Drug Administration stated that consumption of oils containing trans fatty acids contributes to increased blood LDL-cholesterol (“bad” cholesterol) levels, which increase the risk of coronary heart disease (U.S. Department of Health and Human Services, Press Release, Nov. 12, 1999). Hence solidifying oils by hydrogenation is not a desirable option when health benefits are at stake.

Trans fatty acids are present in commercially prepared foods, in partially hydrogenated vegetable oils and, in smaller amounts, in meats and dairy products. The foods that are major contributors to trans fatty acid intake are baked goods such as doughnuts and Danish pastry (37% trans fatty acids), deep-fried foods such as fried chicken and French-fried potatoes (36%), snack chips (35%), imitation cheese (38%), margarines (11-49%), and confectionery fats (27%). The per capita annual consumption of margarine in the United States from 1970 to 1992 has been stable about 5.0 kg/person

Table 1 provides the contents of saturated fats and trans-fat in one serving unit of butter and margarine. The FDA estimates that removal of trans fats from margarine alone would result in a savings up to 50 billion dollars in health care costs related to coronary heart disease.

TABLE 1
The contents of saturated fats and trans-fat in one serving unit of
butter and margarine.*

| | | | | Saturated |
|---|---|---|---|---|
| | Total Fat | Saturated Fat | Trans Fat | and Trans |
| Product | (gr.) | (gr.) | (gr.) | Fats (gr.) |
| Butter | 10.8 | 7.2 | 0.3 | 7.5 |
| Margarine, stick | 11.4 | 2.3 | 2.4 | 4.7 |
| (82% fat) | | | | |
| Margarine, stick | 9.5 | 1.6 | 1.8 | 3.4 |
| (68% fat) | | | | |
| Margarine, tub | 11.2 | 1.9 | 1.1 | 3.0 |
| (80% fat) | | | | |

(*)Butter values from FDA Table of Trans Values, dated 1/30/95. Other values from USDA Composition Data, 1995.

In this specification, such oils and fats, as detailed above, having caloric value of about 9 Kcal/g will be collectively termed “ordinary fats”.

Hence, major research efforts have focused on ways to produce food substances that provide the same functional and organoleptic properties as fats, without the calories and negative health effects. A wide variety of substances have been proposed for use as fat substitutes in food compositions. The chemical structures of such substances are selected such that they are more resistant to breakdown by the metabolic processes of the human digestive system, which normally occur upon ingestion of conventional triglyceride lipids. Because of their increased resistance to digestion and absorption, the number of calories per gram available from these fat substitutes is considerably reduced as compared to common vegetable oils, animal fats, and other lipids. Such substances thus may be utilized in the preparation of reduced calorie food compositions useful in the control of body weight.

U.S. Pat. No. 6,139297 teaches an oil or fat composition comprising 15 wt. % or more of a diacylglycerol and 1.2 to 20 wt. % of phytosterol dissolved or dispersed in a fat and oil. The composition can be used in the same manner as oil and fat in daily life to reduce the serum cholesterol value of a person without significant negative effect on appearance, taste, heating and cooking. Yet, the ability of phytosterols to solidify oils is rather poor, and therefore, the practical utility of such compositions is limited. Moreover, the market price of sterol esters, such as phytosterol is very high, in the range of $15-$20/Kg, making its inclusion in common food product unrealistic.

### SUMMARY OF THE INVENTION

The present invention relates to novel oil and fat compositions containing a solidifying agent, in particular long chain fatty acids and/or long chain fatty alcohols, in an intimate mixture with a fat comprising one or more synthetic fat or oil. The invention further relates to the use of the fat composition in a manner similar to ordinary edible fats while providing health benefits. A further object of the invention is to provide a therapeutic preparation, food or drink containing the fat composition.

According to the present invention, the fat fraction of the fat/solidifying agent composition comprises at least 15% by weight of a single synthetic fat or a combination of synthetic fats, as defined hereinbelow. In one embodiment, the synthetic fat or a synthetic fat combination is 50% by weight or larger, such as 80% by weight of the total fat fraction.

In this specification, unless otherwise indicated, the term synthetic fat refers to artificially-produced edible fatty substance, having caloric value is less than 6 Kcal/g, which is functionally compatible with conventional fats, and that has therapeutic benefits due to its chemical structure and/or its particular metabolic pathways. The production of such fats may involve chemical or enzymatic processing. The terms “synthetic fats”, “fat substitutes” and “fat replacers” are used in this specification interchangeably and synonymously. Synthetic fats are classified by their chemical nature, as exemplified below.

In one aspect of the invention, an oil or fat composition is provided that includes 80 wt. % or more of fat including a synthetic fat having caloric value of less than 6 Kcal/g and 0.1 to 20 wt. % of an edible solidifying agent, dissolved or dispersed in the fat or oil.

In one embodiment, the oil or fat composition is a frying oil. In one embodiment, the weight ratio of the synthetic fat to the solidifying agent or system is 10 to 200.

In one embodiment, the synthetic fat is selected from the group consisting of monoacylglycerol, diacylglycerol, triacylglycerol and sucrose aster, or mixtures thereof at any ratio. In one embodiment, the synthetic fat comprises at least 15% by weight of the total fat, or at least 50% by weight of the total fat, or at least 80% by weight of the total fat. In one embodiment, the fatty acids comprised by the synthetic fat include 50 wt. % or more of unsaturated fatty acids.

In one embodiment, the solidifying agent is a fatty alcohol, having between 15 and 50 carbon atoms in their hydrocarbon chain, or the solidifying agent is a member selected from the group consisting of a long chain fatty alcohol, having molecular weight of at least 200 Da, or the solidifying agent comprises a fatty alcohol, having between 15 and 50 carbon atoms in their hydrocarbon chain, or the solidifying agent comprises a fatty alcohol, selected from cetyl alcohol, stearyl alcohol, arachidyl alcohol, behenyl alcohol (docosanol), octacosanol and 1-triacontanol.

In one embodiment, the solidifying agent comprises a long chain fatty alcohol, wherein the hydrocarbon chain is branched, containing at least one alkyl group side chain, selected from a methyl, ethyl, n-propyl, i-propyl, n-butyl, t-butyl, i-butyl, n-pentyl, i-pentyl, t-pentyl, neo-pentyl, or linear or branched hexyl, heptyl, octyl, nonyl, decyl, lauryl, cetyl or stearyl group, or the solidifying agent comprises a long chain fatty alcohol, wherein at least one additional hydroxyl group linked to the hydrocarbon chain, or solidifying agent comprises at least one double bond in the hydrocarbon chain.

In one embodiment, the solidifying agent comprises a long chain fatty acid, having molecular weight of at least 200 Da, solidifying agent comprises a fatty acid, having between 18 and 50 carbon atoms in their hydrocarbon chain, or the solidifying agent comprises a fatty acid, selected from cetyl alcohol, margaric acid, stearic acid, arachidic acid, behenic acid (docosanic acid), octacosanoic acid and triacontanoic acid, or the long chain fatty acid includes a hydrocarbon chain wherein the hydrocarbon chain is branched, containing at least one alkyl group side chain, or includes at least one additional hydroxyl group linked to the hydrocarbon chain, or includes comprising at least one double bond in the hydrocarbon chain.

In one embodiment, the solidifying agent is selected from edible di-alcohols, having formula A or B.

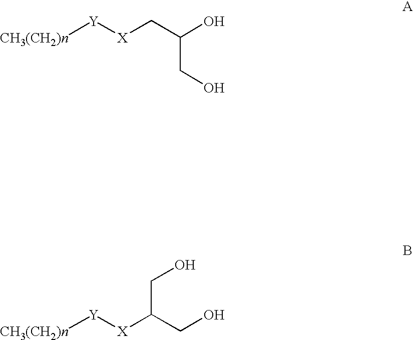

wherein, n is an integer ranging from 8 to 48; X is CHR, O, or NH; Y is CHR or C═O; and R is H or alkyl.

In one embodiment the composition also includes an anti-lipidemic or anti-cholesteremic therapeutic agent, or also includes an anti-lipidemic or anti-cholesteremic therapeutic agent selected from naturally derived or synthetic sterol or stanols (such as alpha.-sitosterol, beta.-sitosterol, stigmasterol, ergosterol, campesterol, .alpha.-sitostanol, .beta.-sitostanol, stigmastanol, campestanol, fatty acid esters thereof and glyco sides thereof.), sterol absorption inhibitors, naturally derived or synthetic or HMG CoA-reductase inhibitors (statins), cholesterol transport inhibitors, omega-3 fats, cholesterol-reducing chromium and vanadium salts and complexes and other herbal extracts, which are known in the art to exert blood lipid and cholesterol levels, or also includes at least one antioxidant, or also includes food additives, selected from (a) savorer such as table salt, sugar, vinegar and seasoning; (b) aroma such as spice and flavor; (c) colorant.

In another aspect of the invention, a food product is provided including the oil or fat composition of 80 wt. % or more of fat including a synthetic fat having caloric value of less than 6 Kcal/g and 0.1 to 20 wt. % of an edible solidifying agent, dissolved or dispersed in the fat or oil.

In another aspect of the invention, a blood cholesterol-reducing therapeutic preparation includes an oil or fat composition an oil or fat composition of 80 wt. % or more of fat including a synthetic fat having caloric value of less than 6 Kcal/g and 0.1 to 20 wt. % of an edible solidifying agent, dissolved or dispersed in the fat or oil.

In another aspect of the invention, a method of reducing a blood cholesterol value includes administering the oil or fat composition of 80 wt. % or more of fat including a synthetic fat having caloric value of less than 6 Kcal/g and 0.1 to 20 wt. % of an edible solidifying agent, dissolved or dispersed in the fat or oil. The solidifying agent or system is a member selected from the group consisting of at least one fatty acid derivative having at least 18 carbon atoms in its carbon chain and at least one fatty alcohol having at least 15 carbon atoms in its carbon chain or mixtures thereof at any ratio, and the composition also includes an anti-lipidemic or anti-cholesteremic therapeutic agent. In one embodiment, the solidifying agent or system is a member selected from the group consisting of at least one fatty acid derivative having at least 18 carbon atoms in its carbon chain and at least one fatty alcohol having at least 15 carbon atoms in its carbon chain or mixtures thereof at any ratio.

In one embodiment, reducing blood cholesterol is accomplished using a composition that also includes a therapeutically effective amount of an anti-lipidemic or anti-cholesteremic therapeutic agent selected from naturally derived or synthetic steros or stanols (such as alpha.-sitosterol, beta.-sitosterol, stigmasterol, ergosterol, campesterol, .alpha.-sitostanol, .beta.-sitostanol, stigmastanol, campestanol, fatty acid esters thereof and glycosides thereof.), sterol absorption inhibitors, naturally derived or synthetic or HMG CoA-reductase inhibitors (statins), cholesterol transport inhibitors, omega-3 fats, cholesterol-reducing chromium and vanadium salts and complexes and other herbal extracts, which are known in the art to exert blood lipid and cholesterol levels, or at least one antioxidant, or food additives, selected from (a) savorer such as table salt, sugar, vinegar and seasoning; (b) aroma such as spice and flavor; (c) colorant.

In another aspect of the invention, an oil or fat-processed food product includes 3 to 95 wt. % of oil or fat comprising 50 wt. % or more of a synthetic fat and 0.1 to 20 wt. % of solidifying agent or system. In one embodiment, the food is a drink, a dessert, an ice-cream, a dressing, a topping, a mayonnaise, a flavoring source for grilled meat, a margarine, a spread, a peanut butter, a frying oil, a baking shortening, potato chips, a snack food, a cake, a cookie, a pie, a bread, a chocolate, a bakery mix, a processed meat product, a frozen entree or a frozen food, or the food is an oil or fat-processed food product of oil-in-water type or an oil or fat-processed food product of water-in-oil type.

In another aspect of the invention, a beverage product includes 0.2 to 10 wt. % of oil or fat comprising 80 wt. % or more of a synthetic fat and 0.1 to 1 wt. % of solidifying agent or system.

In another aspect of the invention, a table cooking oil comprising an oil or fat composition of 80 wt. % or more of fat including a synthetic fat having caloric value of less than 6 Kcal/g and 0.1 to 20 wt. % of an edible solidifying agent, dissolved or dispersed in the fat or oil.

In another aspect of the invention, a therapeutic composition includes the composition of 80 wt. % or more of fat including a synthetic fat having caloric value of less than 6 Kcal/g and 0.1 to 20 wt. % of an edible solidifying agent, dissolved or dispersed in the fat or oil and a therapeutically acceptable carrier.

In another aspect of the invention, a method is provided for decreasing blood cholesterol levels, or for achieving weight loss, comprising administering to a subject in need thereof, an effective amount of the therapeutic composition of the invention.

In another aspect of the invention, a synergistic therapeutic preparation, comprising 80 wt. % or more of fat, comprising at least 15% synthetic fat, having a caloric value of less than 6 Kcal/g and 0.1 to 20 wt. % of an edible solidifying agent, selected from the group consisting of at least one fatty acid derivative having at least 18 carbon atoms in its carbon chain and at least one fatty alcohol having at least 15 carbon atoms in its carbon chain or mixtures thereof at any ratio.

In yet another aspect of the invention, a method of treatment of a human disease, such as hyperlipidemia or hypercholesteremia, comprising administering to a subject in need thereof, an effective amount of the composition of the invention.

### DETAILED DESCRIPTION OF THE INVENTION

Synthetic Fats and Fat Substitutes The

invention provides an oil or fat composition, comprising an oil or fat composition comprising 80 wt. % or more of a synthetic fat or a mixture of fats, of which at least half is a synthetic fat or a combination of synthetic fats, and 0.2 to 20 wt. % of a solidifying agent or solidifying system, dissolved or dispersed in the fat and oil. The amount of the solidifying agent or system of the composition may preferably range from 0.2 to 10wt. %.

Monoacylglycerols and diacylglycerols have long been used as emulsifiers and contribute sensory properties comparable to fats. By using specific fatty acids in the formation of these compounds, it is possible to achieve desired functionality at reduced energy (e.g., 5 kcal/g vs. 9 kcal/g).

One synthetic fat is a long chain diacylglycerol, mainly comprised of unsaturated and/or saturated fatty acids having at least 16 carbon atoms in their carbon atom backbone. The fatty acids of the long chain diacylglycerol preferably include 55 wt. % or more of unsaturated fatty acids, more preferably 70 wt. % or more. Specifically it is preferably composed of 20 to 65 wt. % of oleic acid and 15 to 65 wt. % of linoleic acid. In other embodiments, the synthetic fat is composed of greater than 80 percent diacylglycerol and the diacylglycerol is preferably a mixture of 1,3-diglyceride and 1,2-diglyceride at a ratio of about 7:3. A published study shows that this composition of fat is readily hydrolyzed to monoglycerides and fatty acids in the gastrointestinal tract. The main metabolic product is 1-monoglyceride, which is further hydrolyzed into free fatty acids and glycerol, while the minor product 2-monoglyceride is re-esterified into triglycerides. Clinical trials have demonstrated that such diacylglycerols aid in the maintenance or loss of weight and fat mass, and helps to maintain healthy triglyceride levels in the bloodstream.

Yet another class of useful diacylglycerols include medium chain unsaturated and/or saturated fatty acids having between 8 and 12 carbon atoms in their carbon atom backbone. Mixed diacylglycerols having both long chain fatty acids and medium chain fatty acids are also included in the preferred group of diacylglycerols according to the present invention.

Triacylglycerols comprised of selected short- and long-chain fatty acids can also provide the sensory characteristics of fat with reduced energy content because they are not efficiently absorbed. An example of such triacylglycerols is Salatrim. Salatrim in the brand name of a family of structured triglycerides prepared with a combination short- and long-chain acid triglyceride molecules, is representative of this class of synthetic fats. These structured lipids are made primarily of stearic acid that is less efficiently aborbed by the body than other fatty acids, especially when combined with the short-chain organic acids (SCOAs): acetic (C:2), propionic (C:3), and butyric (C:4) acids. The caloric value of Salatrim is 5 kcal/g, vs. 9 kcal/g for ordinary oil. Table 2 compares the properties of Salatrim and conventional fats and oils.

TABLE 2
Comparison between Salatrim and conventional fats and oils

| Conventional Fat | Salatrim |
|---|---|
| Triglycerides | Triglycerides |
| Good taste/texture | Good taste/texture |
| 9 kcal/g | 5 kcal/g |
| 90-100% available fat | 55% available fat |
| Readily digested and absorbed | Readily digested but less well |
| | absorbed |
| May provide source of and promote | Similar effects on fat-soluble |
| fat-soluble/carotenoid absorption | vitamins/carotenoids as |
| | conventional fat |
| Variable blood lipid effects | No adverse effects on blood lipids |

In human clinical studies, stearic acid absorption efficiencies range from 62% to 94%. The variability is caused by the stearic acid content of the particular triglyceride and the positional specificity of stearic acid on the glycerol moiety. For example, 1,3 and 2,3 distearylglycerides tend to be more poorly absorbed than other combinations. Most of the short-chain organic acids in Salatrim appear to be hydrolyzed in the stomach. The residue entering the small intestine consists of a mixture of mono- and di-stearylglycerides whose physical properties are associated with lower absorption. The amount of unabsorbed stearic acid from Salatrim is greater than that from conventional fats, such as cocoa butter, which enter the small intestine as mixed mono-, di-, and triglycerides composed of stearic, oleic, and palmitic acids. In humans, Salatrim's specific mono-and di-stearylglyceride profile makes the stearic acid less bioavailable than the 78% absorption coefficient observed for free stearic acid. Thus, the use of Salatrim and related synthetic fats can contribute to the metabolic state of a human subject who consumes them instead of regular oils and fats.

Medium-chain triglycerides have long been recognized for their therapeutic potential. Medium-chain triglycerides, having fatty acids with 6-12 carbon atoms in their carbon chain backbone, are metabolized differently than long-chain triglycerides (LCT, C:14-C:24). LCTs are hydrolyzed, then re-esterified to triglycerides, then imported into chylomicrons, which enter the lymphatic system. Medium-chain triglycerides bypass the lymphatic system. They are hydrolyzed to medium-chain fatty acids, which are transported via the portal vein directly to the liver, where they are oxidized for energy. They are not likely to be stored in adipose tissue. For enteral and parenteral feeding, their advantage is already known.

Caprocaprylobehenic triacylglyceride, commonly known as caprenin is manufactured from glycerol by esterification with caprylic (C:8), capric (C:10) and behenic (C:22) fatty acids. Because behenic acid is only partially absorbed and capric and caprylic acids are more readily metabolized than other longer chain fatty acids, caprenin provides only 5 kcal/g.

Another type of synthetic fats binds fatty acids to nontraditional backbones (e.g., sugar) so that enzymes in the human gut are not able to cleave the fatty acids. Thus, they are not absorbed and do not contribute energy. The principle advantage of this latter approach is that such compounds are heat stable and will retain their functional properties in baked and fried foods.

An example for this class of compounds is Olestra. Olestra is a mixture of hexa-, hepta- and, predominantly, octa-esters of sucrose, which are not hydrolyzed in the intestine and are not absorbed. They are formed by reaction between sucrose and fatty acid esters obtained from edible fats and oils (soybean, maize, coconut and cottonseed) of carbon chain length C:8-C:22, and include unsaponifiable materials (0.08-0.3%) present in these fats and oils. It has properties similar to those of a naturally occurring fat. However, unlike the natural products, Olestra provides no calories or saturated fat because it is indigestible. It passes through the digestive tract but is not absorbed into the body.

Another member of this group is Orbestrin, a low-calorie, heat stable, liquid fat substitute composed of fatty acid esters of sorbitol and sorbitol anhydrides. Orbestrin has approximately 1.5 calories per gram and is suitable for use in all vegetable oil applications including fried foods, salad dressing, mayonnaise and baked goods.

Solidifying Agents

Preferred solidifying agents, according to the present invention, include one or more edible long chain fatty acid and/or edible long chain fatty alcohols. Preferably, the edible solidifying agent of the present invention has a molecular weight of at least 200 Da and converts the composition of the oil and the solidifying agent into a thickened/thixotropic composition.

Edible long chain fatty acids, according to the present invention, are fatty acids having 18 or more carbon atoms in their hydrocarbon chain, such as octadecanoic (stearic) acid (Cl18), eicosanoic (arachidic) acid (C20), docosanoic (behenic) acid (C22), tetracosanoic (lignoceric) acid (C24), octacosanoic acid (C28), as well as fatty acids with longer hydrocarbon chains (up to C:50), or mixtures thereof, which are allowed for human ingestion. The edible long chain fatty acids, according to the present invention, further include fatty acids having one or more hydroxyl group attached to the hydrocarbon chain thereof. The concentration of the fatty acid required to obtain a thickened oil-flavor system is inversely related to the length of its hydrocarbon chains. Stearic acid, for example, exerts a considerable thickening effect at about 10-20 % concentration, whereas about 5-10 % concentration is required to achieve the same thickening effect with behenic acid.

Long chain fatty acids may also impart health benefits to the composition. Long chain fatty acids having at least 18 carbon atom in their backbone have recently been shown to improves thrombogenic and atherogenic risk factor profiles in healthy males (Kelly et al., Eur J Clin Nutr 55, p 88, 2001).

Edible long chain fatty alcohol, also referred to in the art as monomeric fatty alcohol, according to the present invention, are fatty alcohols having 15 or more carbons in their hydrocarbon chain, and molecular weight of at least 200 Da, such as cetyl alcohol and stearyl alcohol (or mixtures thereof), which are allowed for human ingestion without restriction (see, U.S. Food and Drug Administration, Center for Food Safety & Applied Nutrition; EAFUS: A Food Additive Database). Other examples of fatty alcohols are arachidyl alcohol (C:20), behenyl alcohol (C:22), 1-triacontanol (C:30)add names of all alcohols, as well as alcohols with longer hydrocarbon chains (up to C:50). The concentration of the fatty alcohol, required to obtain a thixotropic oil-flavor system is inversely related to the length of its hydrocarbon chain.

Long-chained alcohols reduce serum cholesterol levels in experimental models, healthy humans and in type II hypercholesterolemic patients. These aliphatic alcohols have been employed in the treatment of elevated serum cholesterol levels, as reported in a number of published human clinical trials (see for example, Pons P., Mas R., Illnait J., et al., “Efficacy and safety of policosanol in patients with primary hypercholesterolemia”. Curr Ther Res. 1992; 52:507-513).

Yet, another class of solidifying agents according to the present invention comprises long chain fatty acids and/or long chain fatty alcohols having molecular weight of at least 200 Da, and at least one double bond in their hydrocarbon chain.

Long chain fatty acid and/or long chain fatty alcohol, having molecular weight of at least 200 Da, comprising at least one additional hydroxyl group linked to the hydrocarbon chain is another class of solidifying agents.

A further class of solidifying agents according to the present invention comprises long chain fatty acids and/or long chain fatty alcohols, wherein the hydrocarbon chain is branched, containing at least one alkyl group side chain. By way of example, the alkyl group side chain can be a methyl, ethyl, n-propyl, i-propyl, n-butyl, t-butyl, i-butyl, n-pentyl, i-pentyl, t-pentyl, neo-pentyl, or linear or branched hexyl, heptyl, octyl, nonyl, decyl, lauryl, cetyl or stearyl group.

Yet, a further class of solidifying agents according to the present invention comprises long chain fatty acids and/or long chain fatty alcohols having at least one additional hydroxyl group linked to the hydrocarbon chain thereof.

Another class of solidifying agent according to the present invention comprises an edible di-alcohol, having formula A or B as follows:

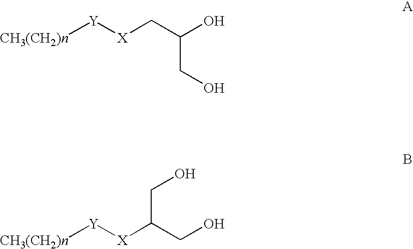

wherein n is an integer ranging from 8 to 48; X is CHR or NH; Y is CHR or C═O; and R is H or alkyl.

The solidifying agent of the present invention can be a component of a natural product such as beeswax, which can be used per se without the separation of the fatty alcohols and/or the fatty acids therefrom. Another class of solidifying agent includes waxes, such as bees wax, or a mixture of fatty alcohols and/or fatty acids derived from such a fatty substance, in which a majority of the fatty alcohol and/or fatty acid has at least 18 carbon atoms in their hydrocarbon chain.

In especially preferred embodiments of the present invention, the solidifying agent is a combination of at least one long chain fatty acid and at least one long chain fatty alcohol, hereinafter referred to as “solidifying system” which enables fine adjustment of the composition's Theological properties.

Typically, the preparation of the oil and fat composition of the present invention comprises the following steps:

1. heating the solidifying agent or the solidifying system to 60 to 80° C. or just above the melting point of the solidifying agent or system, to make it a liquid;

2. heating a synthetic fat to 60 to 80° C.;

3. adding the liquefied solidifying agent or the solidifying system to the synthetic fat in an amount that said solidifying agent or system will be 0.05 to 20 wt. %, and said synthetic fat will be 80 wt. % or more, based on the total weight of the mixture prepared, and mixing thoroughly.

Cooling the mixture spontaneously results in a solidified oil product.

The invention provides a cooking oil comprising an oil or fat composition as defined above, a food product including the oil or fat composition as defined above, a hemal (blood) cholesterol-reducing therapeutic preparation including the oil or fat composition as defined above, an oil or fat-processed food product 1 to 95 wt. % of oil or fat comprising 15 wt. % or more of a synthetic fat and 0.2 to 20 wt. % of solidifying agent or system and a beverage product comprising 0.2 to 10 wt. % of an oil or fat comprising 15 wt. % or more of a synthetic fat and 0.05 to 1 wt. % of solidifying agent or system.

The invention provides also a method of reducing a hemal cholesterol value comprising administering the oil or fat composition as defined above to a person and use of the oil or fat composition as defined above for manufacturing a hemal cholesterol-reducing therapeutic preparation.

As shown above, both the synthetic fat and the solidifying agent of the present invention have been documented to reduce serum cholesterol levels in experimental models and in humans. Hence, use of a mixture containing a synthetic fat and a solidifying agent is especially preferred since it is believed that such a mixture affords a synergistic effect.

Other agents, having lipid and cholesterol-lowering properties can optionally be added to the fat composition of the present invention. Such agents may be selected from naturally derived or synthetic steros or stanols (such as alpha.-sitosterol, beta.-sitosterol, stigmasterol, ergosterol, campesterol, .alpha.-sitostanol, .beta.-sitostanol, stigmastanol, campestanol, fatty acid esters thereof and glycosides thereof.), sterol absorption inhibitors, naturally derived or synthetic or HMG CoA-reductase inhibitors (statins), cholesterol transport inhibitors, cholesterol-reducing chromium and vanadium salts and complexes and other herbal extracts, which are known in the art to exert blood lipid and cholesterol levels.

An edible antioxidant is preferably added to the oil and fat composition of the present invention in an amount of 50 to 2,000 ppm for the purposes of storage stability and flavor stability, as in the case of generally edible fats. The antioxidant preferably comprises one or more members selected among natural antioxidants, tocopherol, tocotrienol, ascorbyl palmitate, ascorbyl stearate, BHT, BHA, phospholipids, etc.

The oil and fat composition of the present invention can be used similarly to generally edible oils and fats and is applicable to fat-processed foods. For example, it is usable in O/W type fat-processed foods such as drinks, desserts, ice creams, dressings, toppings, mayonnaises, and sauces for grilled meat; W/O type fat-processed foods such as margarines and spreads; processed fat foods such as peanut butters, chocolate spreads and fillings, vanilla spreads and fillings, frying and baking shortenings; processed foods such as potato chips, snack cakes, cakes, cookies, pies, breads and chocolates; and other foods including bakery mixes, processed meat products, frozen entrees, and frozen foods.

It is also preferred to use the oil and fat composition of the present invention as a hypocholesteremic preparation in the form of a medicated food product.

The oil or fat composition of the invention will be below explained in details about application to an oil and fat-processed food product.

In the oil or fat-processed food product of the invention, an amount of oil and fat of the food product is preferred to range from 3 to 95 wt. % and that of solidifying agent or system is preferred to range from 0.1 to 20 wt. %. The amount of the synthetic fat of the oil and fat may be 15 wt. % or more, preferably range from 15 to 99.9 wt. %, more preferably from 30 to 99.9 wt. %, in particular preferably from 55 to 99.9 wt. %, most preferably from 80 to 99.9 wt. %.

The oil or fat-processed food product may be prepared by dissolving or dispersing solidifying agent or system in the synthetic fat, as described above, and adding it, in the same manner a conventional oil or fat would be added to such a product. The synthetic fat/solidifying agent mixture can be used as a melt (at temperature above 40° C.) of as a thickened substance, at ambient temperature.

In the invention the oil or fat-processed food product is a processed food product of a mixture of the above shown oil or fat composition and other food material(s). The following is exemplified as the other food materials.

a) edible oil or fat, such as shown above,

b) emulsifier, such as proteins such as egg protein, soy bean protein, milk protein, protein separated from these proteins, protein such as (partial) decomposition products of these proteins, sucrose fatty acid ester, sorbitan fatty acid ester, glycerin fatty acid monoester, lecithin or an enzymaic decomposition product thereof,

c) thickeners, such as thickening polysaccharides such as xanthane gum, gellan gum, guar gum, carageenan, pectin and Tragacanth gum and starches,

d) savorer such as table salt, sugar, vinegar and seasoning,

e) aroma such as spice and flavor,

f) colorant, and

g) anti-oxidant.

Table 3 exemplifies, in a non-limiting fashion, possible applications of the fat composition of the present invention. As seen in the table, a wide variety of food products contain saturated fats and trans fats. It is well known, and was further stated by the Food and Drug Administration (FDA), that the intake of saturated fat is linked to high blood cholesterol, which in turn is linked to increased risk of coronary heart disease (CHD) (See “Lowering Cholesterol” in FDA Consumer, March 1994, and “A Consumer's Guide to Fats” in FDA Consumer, May 1994). The partial hydrogenation process also results in the formation of “trans”-fatty acids, which have recently been shown to possess a plurality of adverse properties. Structurally, trans-fatty acids are similar to saturated fatty acids and hence they influence cell membranes in the same way. Saturated fatty acids elevate the LDL cholesterol levels by inhibiting the LDL receptors and thus inhibiting the removal of cholesterol from the blood. Trans-fatty acids can also raise LDL cholesterol levels in the blood, thus giving rise to the risk of CHD.

Thus, using the synthetic fat compositions of the present invention instead of conventional semi-solid and solid fats, provides a plurality of advantages:

1. the saturated fats and trans fats, which contribute to high LDL cholesterol levels are eliminated from the food product;

2. the synthetic fat compositions of the present invention provide a cholesterol-reducing therapeutic effect;

3. the synthetic fat compositions of the present invention have low caloric value, thus providing a way to lose weight or to avoid weight gain;

4. the texture of the fat compositions of the present invention is essentially compatible to that of conventional semi-solid and solid fats, thus enabling the production of a wide variety of food products, which cannot be produced with the synthetic fat alone;

5. the texture and taste of the food products, using the fat compositions of the present invention are substantially similar to the same products, produced with conventional semi-solid and solid fats. In certain cases a tasting panel found the texture of the food products, produced according to the present invention better than the original products.

TABLE 3
Examples of possible applications of the fat composition of the present
invention

| Food | | |
|---|---|---|
| Product | % Oil | Current Oil |
| Bread | 0.5-5 | Margarine or shortening |
| Cookies | 5-20 | Margarine or shortening |
| Muffin | 5-20 | Margarine or shortening |
| Biscuit | 5-40 | Margarine, shortening and/or plant-derived semi- |
| | | solid and solid fats |
| Cake | 5-20 | Margarine or shortening |
| Pizza | 5-30 | Margarine, shortening and/or plant-derived semi- |
| | | solid and solid fats |
| Pastry | 5-30 | Margarine |
| Doughnuts | 0.5-5 | Margarine or shortening |
| Halvah | 2-10 | Margarine, shortening and/or plant-derived semi- |
| | | solid and solid fats |
| Margarine- | 10-80 | Shortening, hard-stock or plant-derived semi-solid |
| like spread | | and solid fats |
| Chocolate | 10-50 | Margarine, shortening and/or plant-derived semi- |
| spread | | solid and solid fats |
| Chocolate | 10-50 | Cocoa butter substitute and/or plant-derived semi- |
| substitute | | solid and solid fats |
| Filling cream | 10-50 | Highly hydrogenated shortening and/or plant- |
| | | derived semi-solid and solid fats |
| Salad | 5-60 | Vegetable oil, shortening and/or plant-derived |
| dressing | | semi-solid and solid fats |
| Tehina | 0-90 | Sesame oil |
| (sesame | | |
| spread) | | |
| Fresh salads | 1-60 | Butter, animal fat, shortening and/or plant-derived |
| | | semi-solid and solid fats |
| Sauce | 1-60 | Butter, animal fat, vegetable oil, shortening |
| | | and/or plant-derived |
| | | semi-solid and solid fats |
| Ice cream | 1-30 | Butter, highly hydrogenated shortening or |
| | | hydrogenated palm oil |
| Ice cream | 10-50 | Hydrogenated palm or coconut oil |
| coating | | |
| Cake coating | 10-50 | Hydrogenated palm or coconut oil |
| Milk and | 0.1-9 | Milk fat |
| vegetable oil | | |
| Dairy | 0.1-9 | Milk fat |
| products | | |
| (yogurt, | | |
| flavored | | |
| yogurt) | | |
| Cheese (soft, | 1-50 | Milk fat, animal-derived fat and/or plant-derived |
| salted and | | semi-solid and solid fats |
| cottage | | |
| cheese, | | |
| semi-solid | | |
| cheese | | |
| substitute) | | |
| “Low | 1-30 | Shortening |
| cholesterol | | |
| meat | | |
| products” | | |
| (chopped | | |
| meat) | | |
| Sausage | 1-60 | Animal fat, shortening and/or plant-derived semi- |
| | | solid and solid fats |
| Chopped | 1-60 | Animal fat, shortening and/or plant-derived semi- |
| meat | | solid and solid fats |
| products | | |
| (hamburger, | | |
| chicken, | | |
| beef, fish, | | |
| pork) | | |
| Vegetarian | 1-60 | Animal fat, shortening and/or plant-derived semi- |
| meat | | solid and solid fats |
| substitutes | | |
| (chicken, | | |
| beef, fish, | | |
| pork-like) | | |
| Soy-based | 1-30 | Animal fat, shortening and/or plant-derived semi- |
| meat | | solid and solid fats |
| substitutes | | |
| Boullion | 1-30 | Animal fat, shortening and/or plant-derived semi- |
| | | solid and solid fats |
| Dry mix | 1-30 | Shortening, animal fat and/or hydrogenated palm |
| soup | | or coconut oil |

The invention is described with reference to the following non-limited examples, which are presented for the purpose of illustration only.

### EXAMPLE 1

### Basic Shortening

Ingredients: 0.05-4% fatty alcohol, 0.05-4% fatty acid, antioxidant, and a synthetic fat to 100%

The solidifying agents (fatty alcohols and/or fatty acids) are heated to 80° C. The synthetic fat is warmed to 60-80° C. and all ingredients are mixed together, to obtain a clear liquid. Mixture can be used immediately in further processing or cooled down poured to storage containers.

This product was successfully produced with synthetic fats, selected from the classes of diacylglycerols, synthetic triglycerides, such as Salatrim and sucrose esters and related compounds. In the case of synthetic fats with higher melting point, such as caprenin, the thickness of the fat was enhanced. The solidifying agent system may comprise a single fatty alcohol, such as stearyl alcohol and behenyl alcohol; long chain fatty acid, such as behenic acid and mixtures thereof, in any proportion. The total amount of solidifying agents may vary from 0.5% to 20%. The thickening effect is positively correlated with the solidifying agent concentration.

### EXAMPLE 2

### Shortening with 25% Synthetic Fat

Ingredients: 0.05-4% fatty alcohol, 0.05-4% fatty acid, antioxidant, a synthetic fat 25%, and vegetable oil to 100%

The solidifying agents (fatty alcohols and/or fatty acids) are heated to 80° C. The mixture of vegetable oil and synthetic fat is warmed to 60-80° C. and all ingredients are mixed together, to obtain a clear liquid. Mixture can be used immediately in further processing or cooled down poured to storage containers.

This product was successfully produced with synthetic fats, selected from the classes of diacylglycerols, synthetic triglycerides, such as Salatrim and sucrose esters and related compounds. In the case of synthetic fats with higher melting point, such as caprenin, the thickness of the fat was enhanced. Any vegetable oil may comprise the rest of the mixture. The solidifying agent system may comprise a single fatty alcohol, such as stearyl alcohol and behenyl alcohol; long chain fatty acid, such as behenic acid and mixtures thereof, in any proportion. The total amount of solidifying agents may vary from 0.5% to 20%. The thickening effect is positively correlated with the solidifying agent concentration.

### EXAMPLE 3

### Shortening with Modified Plasticity

Ingredients: 92.5 % synthetic fat, 5 % solidifying agent system, 1 % emulsifier, 2.5 % fully hydrogenated soybean oil, and 0.02 % antioxidant mixture.

All ingredients are mixed together at 70° C., to obtain a clear liquid. Mixture can be used immediately in further processing or cooled down poured to storage containers.

This product was successfully produced with synthetic fats, selected from the classes of diacylglycerols, synthetic triglycerides, such as Salatrim and Sucrose esters and related compounds. In the case of synthetic fats with higher melting point, such as caprenin and salatrim, the thickness of the fat was enhanced. The solidifying agent system may comprise a single fatty alcohol, such as stearyl alcohol and behenyl alcohol; long chain fatty acid, such as behenic acid and mixtures thereof, in any proportion. The total amount of solidifying agents may vary from 0.5% to 20%. The thickening effect is positively correlated with the solidifying agent concentration. Emulsifier and fully hydrogenated fat are added to in order to adjust the plasticity of the shortening.

### EXAMPLE 4

### Margarine

Ingredients: 77.5% synthetic oil, 16% water, 1 % mono-diglyceride emulsifier (45 %), 0.5% soy lecithin, 0.5% salt, 0.4% butter flavor, 4% stearyl alcohol, and 0.1% citric acid.

Pre-emulsion was prepared by wanning the synthetic fat to 60° C., adding the stearyl alcohol, emulsifier and lecithin and agitating, to obtain homogeneous solution. Water, salt and citric acid were then added to the mixture. The substance was chilled, rapidly mixed and transferred to jars. The resulting product was similar in consistency to a reference product, which was produced using conventional methods. Yet, the fatty acid profile of the fat fraction of the margarine was similar to the original synthetic fat. It was further found to be useful in spreading on bread and baking.

### EXAMPLE 5

### Additional Margarine Compositions

Table 4 below presents additional compositions for the production of margarines having varying textures.

TABLE 4
Margarine compositions

| | Amount of ingredient per 100 gram | | |
|---|---|---|---|
| | 80% Fat | 60% Fat | 40% Fat |
| Ingredient | Margarine | Margarine | Margarine |
| Water | 16.3 | 33.0 | 51.5 |
| Synthetic fat | 73.0 | 54.0 | 37.0 |
| Behenic acid | 6.0 | 4.1 | 2.7 |
| Stearyl alcohol | 2.8 | 2.8 | 1.2 |
| Fibroline powder | — | 3.5 | 5.0 |
| Modified starch | — | 0.7 | 1.0 |
| Emulsifier | 1.0 | 0.7 | 0.5 |
| Stabilizer | 0.5 | 0.5 | 0.5 |
| Lecithin | — | 0.3 | 0.2 |
| Salt | 0.4 | 0.4 | 0.4 |
| Beta carotene color | As needed | As needed | As needed |
| Butter flavor | As needed | As needed | As needed |

The solidifying agents, behenic acid and stearyl alcohol, were added to a solution of the synthetic fat and the butter flavor and the mixture was heated to 70-75° C., with stirring. All the powder ingredients, except the salt, were added to the water and the aqueous mixture was stirred at room temperature for 15 minutes, using stirrer bladed propeller, to yield a homogeneous paste. The aqueous mixture was then heated gradually on a water bath to 60-65° C., while stirring was continued. The warm oil mixture was then added gradually to the water phase, with stirring, and the final mixture was emulsified, using stirrer blends knife for 60 seconds at 1500 RMP, at 60-65° C. The fine salt was then added and the mixture was further emulsified for 10 seconds at 100 RMP, cooled to 60° C., poured into containers and refrigerated. The resulting margarine was further found to be useful in spreading on bread and baking.

### EXAMPLE 6

### Ice-Cream

Ingredients: 10 % shortening of Example 2, 20% sugar, 1% emulsifier and stabilizer, 69% reconstituted milk and edible flavors and colors.

Pre-emulsion is prepared by warming all ingredients in the oil at 90° C. (Pasteurization). The mixture is homogenized using a high-pressure homogenizer and cooled to 4° C. with agitation, to allow re-crystallization. The re-crystallized mixture was chilled using scrape surface heat exchanger at −5° C., to yield a semi-solid product, which was transferred to final containers, which were, in turn, chilled at −20° C. to −40° C. for final solidification.

### EXAMPLE 7

### Chocolate Spread

Ingredients: 56% fine powder sugar, 32.5% synthetic fat, 6.5% cocoa powder, 2% behenic acid, 1.7% full fat soybean mill, 1% stearyl alcohol, and 0.3% aroma and flavors.

Stearyl alcohol and behenic acid were added to the oil and the mixture was heated to 80° C. Other powders were mixed together. The hot oil mixture was transferred to a jacketed heating/cooling-balling mill (chocolate manufacturing equipment), the powder mixture was added gradually thereto, at 55-60° C., and the final mixture was minced to yield a smooth mass. The warm mixture was then poured into a container and cooled ambient. The resulting spread was further found to be useful in spreading on bread and as filling layer in cakes and wafers.

What is claimed is:

1. An oil or fat composition comprising 80 wt. % or more of fat, comprising a synthetic fat having caloric value of less than 6 Kcal/g and 0.1 to 20 wt. % of an edible solidifying agent, dissolved or dispersed in the fat or oil.

2. The oil or fat composition as claimed in claim 1, in which the synthetic fat is selected from the group consisting of monoacylglycerol, diacylglycerol, triacylglycerol and sucrose aster, or mixtures thereof at any ratio.

3. The composition of claim 1, wherein the synthetic fat comprises at least 15% by weight of the total fat.

4. The composition of claim 1, wherein the synthetic fat comprises at least 50% by weight of the total fat.

5. The composition of claim 1, wherein the synthetic fat comprises at least 80% by weight of the total fat.

6. The oil or fat composition as claimed in claim 1, in which the fatty acids comprised by the synthetic fat include 50 wt. % or more of unsaturated fatty acids.

7. The composition of claim 1, wherein the solidifying agent is a fatty alcohol, having between 15 and 50 carbon atoms in their hydrocarbon chain

8. The composition of claim 1, wherein the solidifying agent is a member selected from the group consisting of a long chain fatty alcohol, having molecular weight of at least 200 Da.

9. The composition of claim 1, wherein the solidifying agent comprises a fatty alcohol, having between 15 and 50 carbon atoms in their hydrocarbon chain.

10. The composition of claim 1, wherein the solidifying agent comprises a fatty alcohol, selected from cetyl alcohol, stearyl alcohol, arachidyl alcohol, behenyl alcohol (docosanol), octacosanol and 1-triacontanol.

11. The composition of claim 8, wherein the solidifying agent comprises a long chain fatty alcohol, wherein the hydrocarbon chain is branched, containing at least one alkyl group side chain, selected from a methyl, ethyl, n-propyl, i-propyl, n-butyl, t-butyl, i-butyl, n-pentyl, i-pentyl, t-pentyl, neo-pentyl, or linear or branched hexyl, heptyl, octyl, nonyl, decyl, lauryl, cetyl or stearyl group.

12. The composition of claim 8, wherein the solidifying agent comprises at least one additional hydroxyl group linked to the hydrocarbon chain.

13. The composition of claim 8, wherein the solidifying agent comprises at least one double bond in the hydrocarbon chain.

14. The composition of claim 1, wherein the solidifying agent comprises a long chain fatty acid, having molecular weight of at least 200 Da.

15. The composition of claim 14, wherein the solidifying agent comprises a fatty acid, having between 18 and 50 carbon atoms in their hydrocarbon chain.

16. The composition of claim 15, wherein the solidifying agent comprises a fatty acid, selected from cetyl alcohol, margaric acid, stearic acid, arachidic acid, behenic acid (docosanic acid), octacosanoic acid and triacontanoic acid.

17. The composition of claim 15, wherein the hydrocarbon chain is branched, containing at least one alkyl group side chain.

18. The composition of claim 14, wherein the solidifying agent comprises at least one additional hydroxyl group linked to the hydrocarbon chain.

19. The composition of claim 14, wherein the solidifying agent comprises comprising at least one double bond in the hydrocarbon chain.

20. The composition of claim 1, wherein the solidifying agent is selected from edible di-alcohols, having formula A or B: 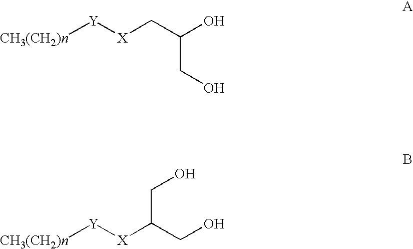
wherein, n is an integer ranging from 8 to 48; X is CHR, O, or NH; Y is CHR or C═O; and R is H or alkyl.

21. The composition of claim 1, also comprising an anti-lipidemic or anti-cholesteremic therapeutic agent.

22. The composition of claim 1, also comprising an anti-lipidemic or anti-cholesteremic therapeutic agent selected from naturally derived or synthetic sterol or stanols (such as alpha.-sitosterol, beta.-sitosterol, stigmasterol, ergosterol, campesterol, alpha.-sitostanol, .beta.-sitostanol, stigmastanol, campestanol, fatty acid esters thereof and glycosides thereof.), sterol absorption inhibitors, naturally derived or synthetic or HMG CoA-reductase inhibitors (statins), cholesterol transport inhibitors, omega-3 fats, cholesterol-reducing chromium and vanadium salts and complexes and other herbal extracts, which are known in the art to exert blood lipid and cholesterol levels.

23. The composition of claim 1, also comprising at least one antioxidant.

24. The composition of claim 1, also comprising food additives, selected from (a) savorer such as table salt, sugar, vinegar and seasoning; (b) aroma such as spice and flavor; (c) colorant.

25. A food product comprising the oil or fat composition as defined in claim 1.

26. A blood cholesterol-reducing therapeutic preparation including the oil or fat composition as defined in claim 1.

27. A method of reducing a blood cholesterol value comprising administering the oil or fat composition as defined in claim 1 to a person.

28. The method as claimed in claim 2 wherein the solidifying agent or system is a member selected from the group consisting of at least one fatty acid derivative having at least 18 carbon atoms in its carbon chain and at least one fatty alcohol having at least 15 carbon atoms in its carbon chain or mixtures thereof at any ratio.

29. The method as claimed in claim 27, wherein the composition also comprises an anti-lipidemic or anti-cholesteremic therapeutic agent.

30. The method as claimed in claim 27, wherein the composition also comprises a therapeutically effective amount of an anti-lipidemic or anti-cholesteremic therapeutic agent selected from naturally derived or synthetic steros or stanols (such as alpha.-sitosterol, beta.-sitosterol, stigmasterol, ergosterol, campesterol, .alpha.-sitostanol, .beta.-sitostanol, stigmastanol, campestanol, fatty acid esters thereof and glycosides thereof.), sterol absorption inhibitors, naturally derived or synthetic or HMG CoA-reductase inhibitors (statins), cholesterol transport inhibitors, omega-3 fats, cholesterol-reducing chromium and vanadium salts and complexes and other herbal extracts, which are known in the art to exert blood lipid and cholesterol levels.

31. The method as claimed in claim 27, wherein the composition also comprises at least one antioxidant.

32. The method as claimed in claim 27, wherein the composition also comprises food additives, selected from (a) savorer such as table salt, sugar, vinegar and seasoning; (b) aroma such as spice and flavor; (c) colorant.

33. An oil or fat-processed food product comprising 3 to 95 wt. % of oil or fat comprising 50 wt. % or more of a synthetic fat and 0.1 to 20 wt. % of solidifying agent or system.

34. The food product as claimed in claim 33, in which the food is a drink, a dessert, an ice-cream, a dressing, a topping, a mayonnaise, a flavoring source for grilled meat, a margarine, a spread, a peanut butter, a frying oil, a baking shortening, potato chips, a snack food, a cake, a cookie, a pie, a bread, a chocolate, a bakery mix, a processed meat product, a frozen entree or a frozen food.

35. The food product as claimed in claim 33, in which the food is an oil or fat-processed food product of oil-in-water type or an oil or fat-processed food product of water-in-oil type.

26. A beverage product comprising 0.2 to 10 wt. % of oil or fat comprising 80 wt. % or more of a synthetic fat and 0.1 to 1 wt. % of solidifying agent or system.

37. A table cooking oil comprising an oil or fat composition as defined in claim 1.

38. The oil or fat composition as claimed in claim 1, wherein said oil or fat composition is a frying oil.

39. The method as claimed in claim 27, wherein the solidifying agent or system is a member selected from the group consisting of at least one fatty acid derivative having at least 18 carbon atoms in its carbon chain and at least one fatty alcohol having at least 15 carbon atoms in its carbon chain or mixtures thereof at any ratio.

40. The composition of claim 1, wherein the weight ratio of the synthetic fat to the solidifying agent or system is 10 to 200.

41. A therapeutic composition, comprising the composition of claim 1 and a therapeutically acceptable carrier.

42. A method for decreasing blood cholesterol levels, comprising administering to a subject in need thereof, an effective amount of the therapeutic composition of claim 41.

43. A method for achieving weight loss, comprising administering to a subject in need thereof, an effective amount of the therapeutic composition of claim 41.

44. A method for decreasing blood cholesterol levels, comprising administering to a subject in need thereof, an effective amount of the composition of claim 1.

45. A synergistic therapeutic preparation, comprising 80 wt. % or more of fat, comprising at least 15% synthetic fat, having a caloric value of less than 6 Kcal/g and 0.1 to 20 wt. % of an edible solidifying agent, selected from the group consisting of at least one fatty acid derivative having at least 18 carbon atoms in its carbon chain and at least one fatty alcohol having at least 15 carbon atoms in its carbon chain or mixtures thereof at any ratio.

46. A method of treatment of a human disease, comprising administering to a subject in need thereof, an effective amount of the composition of claim 45.

47. A method of treatment of a hyperlipidemia or hypercholesteremia comprising administering to a subject in need thereof, an effective amount of the food product of claim 25.
